(19) United States
(12) Patent Application Publication
(10) Pub. No.: US 2023/0073687 A1
(43) Pub. Date: Mar. 9, 2023

(54) Roof Module for a Motor Vehicle Comprising a Sensor System

(71) Applicant: Webasto SE, Stockdorf (DE)

(72) Inventors: Thomas LINDNER, Stockdorf (DE); Andreas STRAßER, Stockdorf (DE); Michael HUELSEN, Stockdorf (DE)

(21) Appl. No.: 17/793,509

(22) PCT Filed: Feb. 3, 2021
(86) PCT No.: PCT/EP2021/052549

§ 371 Date: Jul. 18, 2022

(30) Foreign Application Priority Data
Feb. 5, 2020 (DE) 10 2020 102 874.1

(51) Int. Cl. B60H 1/00; B60H 1/24; B62D 25/06; B60R 11/04

(52) U.S. Cl. CPC B60H 1/00271; B60H 1/245; B62D 25/06; B60R 11/04; B60H 2001/00235

(57) ABSTRACT

A roof module for a motor vehicle, in particular for a passenger car, the roof module comprising a roof skin disposed on a roof substructure and a sensor system comprising at least one sensor module having at least one environment sensor for detecting the vehicle environment. The roof skin covers an air-conditioning mechanism having a thermal channel arrangement via which a cooling and/or heating fluid flows to the sensor module and/or an electrical feature of the roof module.

The invention relates to a roof module for a motor vehicle, in particular for a passenger car, the roof module comprising the features of the preamble of claim 1.

A roof module of this kind is known from practice and is in particular a roof element of a passenger car which can be placed, as a separate component, on top of a vehicle body forming a vehicle body shell and having roof side rails for forming a vehicle roof between which the roof module is accommodated. The roof module can be a purely fixed roof element which is entirely closed, i.e., light-proof, or which can have a transparent portion for forming a panoramic roof, the transparent portion forming a roof see-through portion. Alternatively, the roof module can comprise a roof opening system which has a displaceable cover element by means of which a roof opening formed in the roof module can be opened or closed at will. An outer visible surface of the roof module is formed by a roof skin, which can be partially transparent in the case of a fixed roof element so as to form a roof see-through portion and which borders the roof opening in the case of a roof module having a roof opening system. In the installed state, the roof module is tightly connected to the roof side rails.

The known vehicle roof further comprises a sensor system which comprises a sensor module having multiple environment sensors for detecting a vehicle environment. The sensor module, by means of which the vehicle environment can be detected and analyzed, enables the motor vehicle in question to drive autonomously or semi-autonomously. The sensor module is placed on top of the vehicle roof, i.e., the roof skin, since the latter is typically the highest point of a vehicle, from where the vehicle environment is easily visible. Known sensor modules operate in a specified temperature range only, which is below 60° C.

The object of the invention is to provide a vehicle roof which is configured according to the kind described above and whose sensor system works reliably even at very high and/or very low ambient temperatures, allowing it to be used in an autonomously or semi-autonomously driving motor vehicle.

According to the invention, this object is attained by the roof module having the features of claim 1.

So the invention proposes a roof module for a motor vehicle, in particular for a passenger car, the roof module comprising a roof skin disposed on a roof substructure and a sensor system comprising at least one sensor module having at least one environment sensor for detecting a vehicle environment. The roof skin covers an air-conditioning mechanism having a thermal channel arrangement via which a cooling and/or heating fluid flows to the sensor module and/or to an electrical feature of the roof module.

The thermal channel arrangement is thus used to cool or heat the sensor module. If the roof module is provided with multiple sensor modules, as is typically the case, the thermal channel arrangement can be used to jointly cool or heat the sensor modules. So the invention provides an air-conditioning concept for joint air conditioning of the sensor modules of a roof module, making it possible for the sensor modules to be kept at or brought to a suitable operating temperature in an integrated manner.

Alternatively or additionally, the thermal channel arrangement can be used to cool or heat other electrical features, which comprise an antenna module, a controller, a communication feature, a light, and/or the like.

The cooling and/or heating fluid can basically be a gas, such as air, or a liquid, such as water, refrigerant, oil, or the like.

The roof skin of the roof module according to the invention forms the upper, i.e., outer, visible surface of the roof module and in particular extends as far as to the longitudinal edges and/or the transverse edges of the roof module.

The substructure on which the roof skin is disposed comprises in particular a roof frame, which can form an intersection with a vehicle body, for example, with longitudinal roof rails and/or transverse roof rails of the vehicle body, when the roof module is in the installed state. The roof frame is covered by the roof skin and can serve to fix the roof skin. Also, the roof frame, which forms a support structure of the roof module, can be a support unit for the at least one sensor module.

In a specific embodiment of the roof module according to the invention, the air-conditioning mechanism, which comprises at least the thermal channel arrangement, additionally has a connecting element via which it can be connected to an air-conditioning duct of an air-conditioning system of the vehicle, the air-conditioning duct being disposed in a body pillar of the vehicle, the cooling and/or heating fluid being transported from the connecting element to the sensor module via the thermal channel arrangement. So in this embodiment, an air condition, which is in particular provided in a motor vehicle anyway, or another cooling or heating mechanism can be used to air-condition the sensor module. Such a cooling or heating mechanism is used, for example, for a combustion engine or an electric motor, for power electronics, for a battery, or for other vehicle areas.

In another specific embodiment of the roof module according to the invention, the air-conditioning mechanism, which is integrated in the roof module, can comprise an air-conditioning unit which supplies the thermal channel arrangement with the cooling and/or heating fluid. The air-conditioning unit can be an air-conditioning component, such as a compressor, a fan, a heat pump, and/or a heat exchanger.

In another specific embodiment of the roof module according to the invention, the air-conditioning arrangement comprises a central unit which supplies multiple thermal channels of the thermal channel arrangement with the cooling and/or heating fluid, the thermal channels leading to multiple sensor modules and/or electrical features. The central unit can comprise a compressor, a fan, a heat exchanger, a heat pump, and/or the like. For example, a central fan distributes the air-conditioning medium, i.e., the cooling and/or heating fluid, to the thermal channels and thus to the sensor modules. The central fan can form the air-conditioning unit and may have an intersection via which it is connected to the above-described air-conditioning duct of the on-board air-conditioning system. Alternatively, the central fan can be connected to the environment only so that ambient air can be aspirated as the cooling and/or heating fluid.

Advantageously, the sensor module comprises a heat exchanger for the cooling and/or heating fluid, the heat exchanger being connected to the thermal channel arrangement. Thus, the temperature of the sensor module in question can be controlled efficiently.

The thermal channel arrangement according to the invention can basically be configured as an open or a closed channel system. In the case of a closed embodiment, in which the thermal channel arrangement is part of a closed channel system, at least one fluid return channel leading to an air-conditioning unit is provided. The air-conditioning unit can comprise a compressor, a heat exchanger, and/or another unit which controls the temperature of the cooling and/or heating fluid and which belongs to the air-conditioning mechanism disposed in the roof module or to an air-conditioning system of the vehicle on which the roof module according to the invention is disposed.

In a preferred embodiment of the roof module according to the invention, the sensor module has a temperature sensor which is connected to a control unit of the air-conditioning mechanism or of the air-conditioning system of the vehicle for precisely adjusting or controlling the operating temperature of the sensor module.

As discussed above, the air-conditioning unit of the air-conditioning mechanism of the roof module according to the invention can have an air-conditioning component in the form of a compressor or a heat exchanger. When a heat exchanger is used, the latter is advantageously connected to the thermal channel arrangement, the cooling and/or heating fluid being brought to a target temperature in the heat exchanger in order to be subsequently transported to the sensor module via the thermal channel arrangement and to bring or keep the sensor module to/at an intended target operating temperature.

The thermal channel arrangement, via which the temperature of the at least one sensor module can be set, can also be used to air-condition other structural elements or structural units of the roof module. For example, the roof module according to the invention comprises, as another electrical feature, a light feature which can be used as a light system in the interior of the vehicle in question and which is configured as an ambient light feature, for example. This light feature can in turn be connected to the thermal channel arrangement, in particular a rear ventilation of the light feature via the thermal channel arrangement being possible. Additionally or alternatively, the roof module according to the invention can comprise an antenna module connected to the thermal channel arrangement. The antenna module serves to communicate with corresponding communication partners, such as radio masts or other road users. The antenna module can comprise an active antenna and an associated controller.

In a specific embodiment of the roof module according to the invention, the roof skin comprises solar cells supplying an electrical feature of the air-conditioning mechanism with electrical energy so as to be able to keep the sensor module at an operating temperature in particular when the vehicle in question is parking. In this way, a so-called auxiliary ventilation or a heater for cooling for heating the sensor module is operated, which ensures that the sensor module is operational without delay.

The roof module according to the invention can be a purely fixed roof or comprise a roof opening system by means of which a roof opening formed in the roof skin can be closed or opened at will.

The roof skin preferably covers not only the thermal channel arrangement but also the at least one sensor module. In this case, a sensor see-through area through which the environment sensor can detect the vehicle environment is formed in the roof skin.

The environment sensor of the roof module according to the invention can be configured in various ways and can in particular be a sensor which uses electromagnetic radiation and/or acoustic waves and can comprise a lidar sensor, a radar sensor, an optical sensor, such as a camera, an antenna unit, and/or the like. So systems which are employed for orientation and communication of the vehicle with its environment can also be considered environment sensors within the meaning of the invention. Antenna units, in particular active antennas, or control devices for communication and/or ranging are also considered environment sensors.

If the environment sensor of the sensor module is a lidar sensor, it preferably operates in a wavelength range of about 905 nm or about 1550 nm. A camera used as an environment sensor can operate in the wavelength range of visible light and/or in the infrared range.

The invention provides a roof sensor module (RSM) which enables the vehicle in question to drive autonomously or semi-autonomously by means of the sensor system.

In an integrated manner, the roof module according to the invention forms a structural unit in which components required for autonomous or semiautonomous driving of the motor vehicle are accommodated. A plurality of functional elements, such as the at least one sensor module and the air-conditioning mechanism with the thermal channel arrangement, can be integrated in the roof module. The structural unit can be connected to a vehicle body or a vehicle body shell, which can comprise side rails, i.e., longitudinal roof rails, transverse roof rails, and/or other body shell support elements as an intersection with the roof module, in particular with the roof substructure or a roof frame thereof, by a vehicle manufacturer so as to form the vehicle roof.

The roof module according to the invention can basically be part of any road- or rail-bound motor vehicle. In particular, however, the roof module according to the invention is part of a roof of a passenger car. Yet it can also be employed in a roof of a utility vehicle, which is a delivery van, an autonomously driving small bus, such as a so-called people mover, or a tractor unit, for example.

The invention also relates to a motor vehicle comprising a roof module of the kind described above.

The motor vehicle is in particular an autonomously or semi-autonomously driving vehicle, which drives autonomously without at least substantial intervention of a driver when in the autonomous driving mode. In a semi-autonomous driving mode, the roof module forms part of a driver assistance system, for example.

Other advantages and advantageous configurations of the subject matter of the invention are apparent from the description, the drawing, and the claims.

Illustrative examples of a roof module according to the invention are schematically illustrated in the drawing and will be discussed in more detail in the following description.

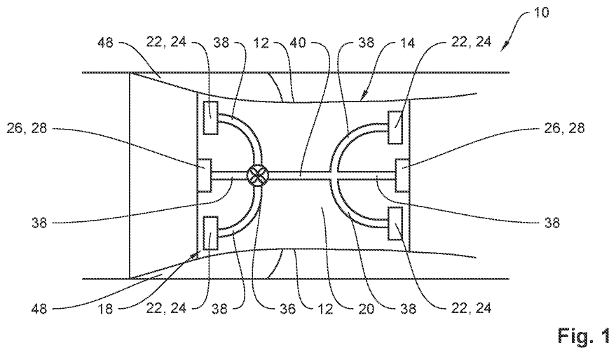

FIG. 1 is a schematic top view of a motor vehicle having a vehicle roof comprising a roof module according to the invention;

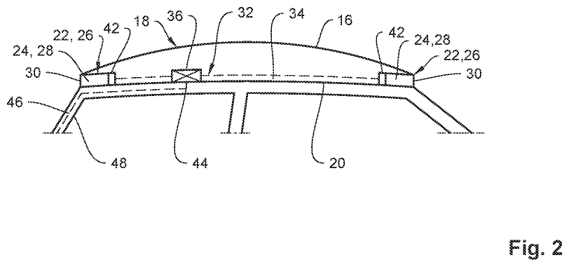

FIG. 2 is a longitudinal section of the vehicle roof of the motor vehicle of FIG. 1;

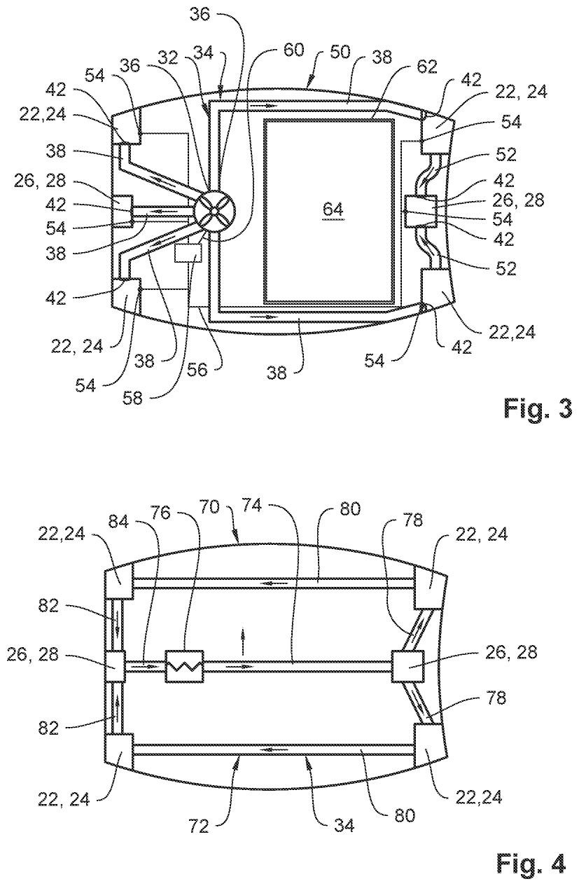

FIG. 3 is a schematic top view of a second embodiment of a roof module;

FIG. 4 is a schematic top view of a third embodiment of a roof module;

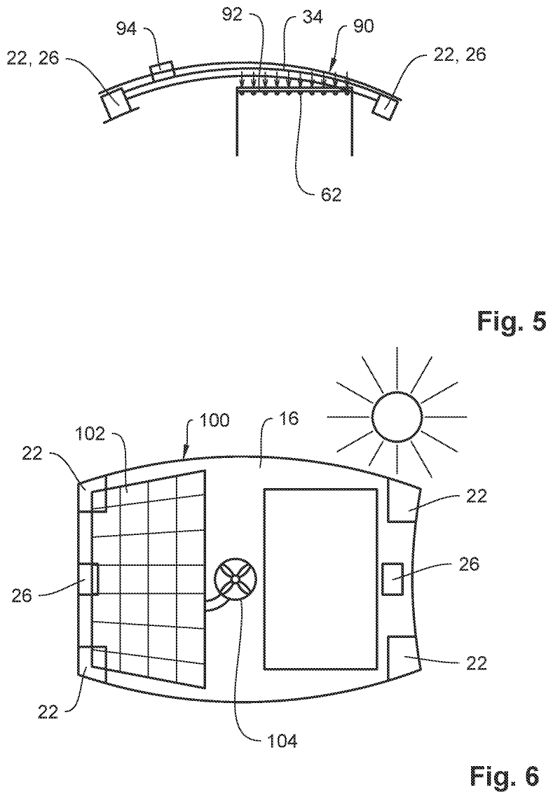

FIG. 5 is a schematic longitudinal section of a fourth embodiment of a roof module; and

FIG. 6 is a schematic top view of a fifth embodiment of a roof module.

FIGS. 1 and 2 show a motor vehicle 10, which is a passenger car and has a vehicle body shell or a vehicle body, which is provided with a roof side rail 12 on either side of a vertical longitudinal center vehicle plane. A roof module 14, which forms a vehicle roof together with both roof side rails 12, is disposed between bilaterally disposed roof side rails 12.

Roof module 14 comprises a roof skin 16, which forms an outer visible surface of roof module 14 and is attached to a circumferential roof frame, which is part of a roof substructure and which is a support structure 20 of roof module 14 and which forms an intersection between roof module 14 and roof side rails 12.

In an integrated manner, the roof module 14 is configured as a roof sensor module (RSM), which has devices which enable motor vehicle 10 to drive autonomously. To this end, roof module 14 has a sensor system 18, which comprises a sensor module 22 in each of the four corner areas of roof module 14, sensor modules 22 being placed on top of support structure 20 of roof module 14. Sensor modules 22 each comprise at least one environment sensor 24, by means of which the environment of motor vehicle 10 can be detected, allowing motor vehicle 10 to be operated in an autonomous driving mode. In addition to sensor modules 22, sensor system 18 comprises a sensor module 26 disposed centrally at the front edge and a sensor module 26 disposed centrally at the rear edge of roof module 14, each sensor module 26 also being equipped with an environment sensor 28 for detecting the vehicle surroundings. Sensor modules 26, too, are placed on top of support structure 20 of roof module 14. As can be seen in FIG. 2, roof skin 16 of roof module 14 covers sensor modules 22 and 26, thus forming a cover for sensor modules 22 and 26. Moreover, roof skin 16 forms respective end faces in the area of sensor modules 22 and 26, the end faces each being formed by a vertical wall 30 of roof skin 16 and forming respective sensor see-through areas for environment sensors 24 and 28. Furthermore, roof skin 16 extends as far as to the edges of the roof module which extend in the transverse roof direction and in the longitudinal roof direction.

Environment sensors 24 and 28 of sensor modules 22 and 26 can be configured in various ways and can comprise a lidar sensor, a radar sensor, a camera, and/or any other suitable sensor, for example. The camera can in particular be a stereo camera and/or an infrared camera. Walls 30, which form the sensor see-through areas, are transparent to wavelengths between 200 nm and 2000 nm. A transparency to radar radiation may be required as well.

In order to be able to bring sensor modules 22 to an intended operating temperature and maintain the operating temperature, roof module 14 is equipped with an air-conditioning mechanism 32, which is covered by roof skin 16 and comprises a thermal channel arrangement 34, which connects a central air-conditioning unit 36 to sensor modules 22 and 26. To this end, thermal channel arrangement 34 comprises six thermal channels 38 in the case at hand, each of which leads to one of sensor modules 22 and 26, the thermal channels 38 that are assigned to rear sensor modules 22 and 26 being connected to a collecting channel 40, whose other end is connected to air-conditioning device 36.

Present air-conditioning unit 36 can be a fan without additional heating or cooling. Alternatively, air-conditioning unit 36 can also comprise a heater and/or a cooling unit. It is also conceivable for air-conditioning unit 36 to be a combination device, meaning it comprises features, such as a fan, a heating device, and/or a cooling unit, which can be operated individually or in combination. Air-conditioning unit 36 provides sensor modules 22 and 26 with a cooling and/or heating fluid via thermal channel arrangement 34, the cooling and/or heating fluid being air in the case at hand. Sensor modules 22 and 26 are each provided with a heat exchanger 42 and/or with a heat sink and/or a heat-conducting element so as to be able to absorb the cold and/or the heat of the cooling and/or heating fluid.

Furthermore, air-conditioning mechanism 32 can be connected to an air-conditioning duct 46 via a connecting element 44, air-conditioning duct 46 being connected to an air condition of motor vehicle 10 and disposed in an A-pillar 48 or another body pillar of the vehicle body on which the vehicle roof is disposed.

FIG. 3 shows a roof module 50, which is an alternative embodiment to the roof module illustrated in FIGS. 1 and 2. Like the roof module of FIGS. 1 and 2, roof module 50 comprises a sensor module 22 with an environment sensor 24 in each of its corner areas on a roof frame and a sensor module 26 with an environment sensor 28 both in both its front edge area and its rear edge area.

Like the roof module of FIGS. 1 and 2, roof module 50 comprises an air-conditioning mechanism 32, which is covered by roof skin 16 and has a thermal channel arrangement 34. Thermal channel arrangement 34 comprises five thermal channels 38, which lead from a central air-conditioning device 36 to front sensor modules 22 and 26, which are disposed in the corner areas, and to rear sensor modules 22, which are disposed in the corner areas. Moreover, thermal channel arrangement 34 comprises two thermal channels 52, which are connecting channels and each connect one of sensor modules 22, which are disposed in the corner areas, with sensor module 26 disposed centrally at the rear. Air-conditioning unit 36 can be configured according to the air-conditioning unit of the embodiment of FIGS. 1 and 2. Accordingly, sensor modules 22 and 26, which are disposed below roof skin 16, each also comprise a heat exchanger 42, which transfers the heat or the cold of the heating and/or cooling fluid running in thermal channels 38 and 52 to sensor modules 22 and 26.

In order to be able to control the temperature level in sensor modules 22 and 26, they each have a temperature sensor 54, which detects the temperature of sensor module 22 or 26 and is connected to a control unit 58 via electrical lines 56, control unit 58 in turn being connected to air-conditioning unit 36 via a control line 60.

Furthermore, roof module 50 is provided with a roof opening 62, which can be opened or closed at will by means of a cover element 64 of a roof opening system.

The air-conditioning mechanisms illustrated in FIGS. 1 to 3 are open systems; i.e., the cooling and/or heating fluid provided to sensor modules 22 and 26 via thermal channel arrangement 34 is discharged to the environment instead of being returned.

FIG. 4 shows a roof module 70, which, like the embodiment of FIGS. 1 and 3, is also provided with a sensor module 22 at each of its corner areas, each sensor module 22 comprising at least one environment sensor 24 like the embodiment described above. Both at the front edge and at the rear edge, roof module 70 also has a centrally disposed sensor module 26 comprising an environment sensor 28. Like in the embodiments illustrated in FIGS. 1 to 3, sensor modules 22 and 26, which are disposed on the roof frame or the roof substructure, are covered by roof skin 16. Moreover, roof module 70 comprises an air-conditioning mechanism 72, by means of which sensor modules 22 and 26 can be brought to an intended operating temperature and maintained at this operating temperature.

Air-conditioning mechanism 72, which is covered by roof skin 16, comprises a thermal channel arrangement 34, which comprises a thermal channel 74, thermal channel arrangement 34 leading from a heat exchanger 76, which is a central air-conditioning unit, to the central sensor module 26 disposed at the rear. Two thermal channels 78, which transport the gaseous or liquid cooling and/or heating fluid supplied by thermal channel 74 to the sensor modules 22 disposed in the rear corner areas, branch off in rear sensor module 26. Rear sensor modules 22, which are disposed in the corner areas, are each connected to the front sensor module 22 disposed on their roof side via a thermal channel 80, whereby the cooling and/or heating fluid can be transported to respective front sensor module 22. Respective thermal channels 82 are formed between front sensor modules 22, which are disposed in the corner areas, and front sensor module 26, which is disposed centrally. A return line 84, which can return the cooling and/or heating fluid back to heat exchanger 76 for renewed temperature treatment, branches off from front sensor module 26. So thermal channel arrangement 34 of air-conditioning mechanism 32 is a closed system, heat exchanger 76 being the central air-conditioning device. Entire air-conditioning mechanism 72 including thermal channel arrangement 34 and sensor modules 22 and 26 is covered by roof skin 16.

In principle, the fluid in thermal channel arrangement 34 illustrated in FIG. 4 can also flow in the opposite direction.

FIG. 5 shows a roof module 90, which largely corresponds to the roof module illustrated in FIG. 3, which is why reference is made to the above description in this regard. Moreover, roof module 90 comprises a light feature 92 in the form of LED light strips along each of the lateral edges of roof opening 62; the LED light strips can be cooled via thermal channel arrangement 34 using cooling air running in thermal channel arrangement 34 for ventilating light features 92 from the rear.

Furthermore, roof module 90 comprises an antenna module 94, which is used for communication of the vehicle in question with radio masts, other road users, and/or the like. For cooling, antenna module 94 is also connected to thermal channel arrangement 34, allowing antenna module 94 to also be kept at a suitable operating temperature.

Otherwise, roof module 90 corresponds to that of FIG. 3.

FIG. 6 shows a top view of a roof module 100, which largely corresponds to the embodiment of FIG. 3 but additionally comprises an array of solar cells 102 on roof skin 16, the array supplying a central air-conditioning unit, such as a fan 104, with electrical energy so that the sensor modules can be kept at a temperature suitable for operation via thermal channel arrangement 34 by means of fan 104 even when the motor vehicle is parked. Otherwise, reference is made to the description of the embodiment of FIG. 3.

### REFERENCE SIGNS

10 motor vehicle
12 roof side rail
14 roof module
16 roof skin
18 sensor system
20 support structure
22 sensor module
24 environment sensor
26 sensor module
28 environment sensor
30 wall
32 air-conditioning mechanism
34 thermal channel arrangement
36 air-conditioning unit
38 thermal channel
40 collecting channel
42 heat exchanger
44 connecting element
46 air-conditioning duct
48 A-pillar
50 roof module
52 thermal channel
54 temperature sensor
56 electrical line
58 control unit
60 control unit
62 roof opening
64 cover element
70 roof module
72 air-conditioning mechanism
74 thermal channel
76 heat exchanger
78 thermal channel
80 thermal channel
82 thermal channel
84 return line
90 roof module
92 light feature
94 antenna module
100 roof module
102 solar cells
104 fan

1. A roof module for a motor vehicle, the roof module comprising:
a roof skin disposed on a roof substructure and
a sensor system comprising at least one sensor module having at least one environment sensor for detecting the vehicle environment,
wherein the roof skin covers an air-conditioning mechanism having a thermal channel arrangement via which a cooling and/or heating fluid flows to the sensor module and/or an electrical feature of the roof module.

2. The roof module according to claim 1, wherein the air-conditioning mechanism comprises a connecting element via which it is connectable to an air-conditioning duct of an air-conditioning system of the vehicle, the air-conditioning duct being disposed in a body pillar of the vehicle, the thermal channel arrangement transporting the cooling and/or heating fluid from the connecting element to the sensor module.

3. The roof module according to claim 1, wherein the air-conditioning mechanism comprises an air-conditioning unit supplying the thermal channel arrangement with the cooling and/or heating fluid.

4. The roof module according to claim 1, wherein the air-conditioning mechanism comprises a central unit supplying multiple thermal channels of the thermal channel arrangement, which lead to multiple sensor modules, with the cooling and/or heating fluid and comprising a fan, a heat exchanger, and/or a heat pump.

5. The roof module according to claim 1, wherein the sensor module comprises a heat exchanger for the cooling and/or heating fluid, the heat exchanger being connected to the thermal channel arrangement.

6. The roof module according to claim 1, wherein the thermal channel arrangement is part of a closed channel system comprising at least one fluid return channel leading to an air-conditioning unit.

7. The roof module according to claim 1, wherein the thermal channel arrangement is connected to a heat exchanger of the air-conditioning mechanism, the cooling and/or heating fluid being brought to a target temperature in the heat exchanger in order to be transported to the sensor module via the thermal channel arrangement.

8. The roof module according to claim 1, wherein the sensor module is provided with a temperature sensor connected to a control unit of the air-conditioning mechanism via an electrical line.

9. The roof module according to claim 1, wherein the electrical feature comprises a light feature connected to the thermal channel arrangement.

10. The roof module according to claim 1, wherein the electrical feature comprises an antenna module connected to the thermal channel arrangement.

11. The roof module according to claim 1, wherein the roof skin comprises solar cells supplying an electrical feature of the air-conditioning mechanism with electrical energy.

12. The roof module according to claim 1, wherein the roof module comprises a roof opening and a roof opening system for a roof opening.

13. A motor vehicle comprising a roof module according to claim 1.
